(19) United States
(12) Patent Application Publication
(10) Pub. No.: US 2005/0207605 A1
(43) Pub. Date: Sep. 22, 2005

(54) Microphone and method of producing a microphone

(75) Inventors: Alfons Dehe, Neufahrn (DE); Marc Fueldner, Munich (DE)

Correspondence Address: Maginot, Moore & Beck;Bank One Tower, Suite 3000, 111 Monument Circle, Indianapolis, IN, 46204, US

(73) Assignee: Infineon Technologies AG, Munchen (DE)

(21) Appl. No.: 11/075,039

(22) Filed: Mar. 8, 2005

(30) Foreign Application Priority Data
Mar. 8, 2004 (DE) 10 2004 011149.9

(51) Int. Cl. H04R 25/00

(52) U.S. Cl. 381/369

(57) ABSTRACT

A microphone has a substrate including an acoustically transparent substrate region, a lid with an acoustically transparent lid region, and a membrane which is held by a membrane carrier between the lid and the substrate. The acoustically transparent substrate region or the acoustically transparent lid region is provided with at least one impedance hole sized so that an acoustic impedance of the impedance hole is larger than an acoustic impedance of the acoustically transparent region of the respective other region of substrate region and lid region.

### CROSS-REFERENCE TO RELATED APPLICATION

This application claims priority from German Patent Application No. 10 2004 011 149.9, which was filed on Mar. 8, 2004, and is incorporated herein by reference in its entirety.

### BACKGROUND OF THE INVENTION

1. Field of the Invention

The present invention relates to a microphone and a method for producing a microphone and, in particular, to a microphone with directional sensitivity characteristic.

2. Description of the Related Art

More and more, microphones performing the conversion of an acoustic signal to an electric signal are used in technical devices. An increasing improvement of the processing of voice signals in means downstream with respect to the microphones, such as digital signal processors, requires the properties of the microphones to be improved also, because the quality of voice transmission continues to improve. In addition, microphones are increasingly used in portable devices, such as mobile phones or laptops with voice recognition, which, in turn, are often used by the consumers in places where there are many acoustic interfering sources, such as train stations or airports. This results in an improved directivity being required of the microphones used in the devices. The aim is to filter out interfering sound sources whose sound waves do not come from the direction of the actual sound signal source. In addition, the advancing miniaturization of the devices such as mobile phones or PDAs also demands that the components, such as the microphones, used therein are reduced in their dimensions as well. At the same time, the increasing competition with respect to the price of these devices, such as laptops with voice recognition systems or mobile phones, calls for simplifying the manufacturing method for microphones and, in particular, for microphones with directivity.

For the last few decades, people skilled in the art of electroacoustics have been working on the design of microphones which show a directional characteristic, i.e. which receive a signal from a preferred direction better than from another direction. The use of acoustic travel time elements and of acoustic filters suggests itself for this.

The book “Elektroakustik” whose third edition was published by Springer-Verlag in 1993 shows designs of directional microphones described in FIGS. 4 and 5.

FIG. 4 explains such a filter element. The filter element includes a membrane 1, side walls 11, sound holes 21 and a back wall 31. Arrow 41a represents a direct path of a frontal sound wave onto the membrane 1, while arrow 41b represents a path of a frontal sound wave onto the membrane 1 via an interior 32 of the microphone. What is referred to here as the frontal sound wave is the sound wave coming from the direction of the membrane 1 and perpendicularly impinging on the membrane 1. An arrow 51a shows a path of a sound wave from the back impinging on the membrane on the outside of the microphone, arrow 51b shows the path of the sound wave from the back which enters the interior of the microphone via the sound hole 21 and impinges on the membrane 1 there.

The result is an acoustic travel time element. For the frontal sound waves, a path and thus pressure difference results. For the sound waves from the back, this pressure difference becomes zero.

FIG. 5 shows an expansion of the embodiment according to prior art shown in FIG. 4. What can be seen in this arrangement is the membrane 1, the side wall 11, the microphone interior 32, a cavity 61 in the microphone interior 32, an attenuation element 71 at the entry of the cavity 61 and an attenuation element 81 at the entry of the microphone interior 32.

In order to increase the sensitivity of such microphones at low frequencies, phase rotating acoustic filters are set on the membrane backside. A second cavity 61 is coupled to the cavity 32 behind the membrane 1 via an attenuation felt 71. A connection to the outside exists via a tube 81.

In polar diagrams, an acoustic attenuation of an arrangement may be plotted as a function of an angle of incidence of the sound waves, wherein the sound waves arriving parallel to the membrane surface normal have an angle of 0°. With suitable selection of corresponding geometries in the acoustic travel time elements, these polar diagrams have the form of a kidney, a super kidney or a hyper kidney.

WO 02/45463 A2 also shows microphones having a further sound hole in addition to the access to the membrane 1, the second sound inlet hole, however, is as large as the sound inlet hole to the membrane and thus is no impedance hole. Prior art microphones with directional characteristic produce a directional characteristic by an arrangement of several microphones in a space which are located at different positions, and perform a subsequent processing of the signals from these microphones in a common processing unit. These arrangements are explained in patent applications EP 1 065 909 A2, EP 1 081 985 A2, U.S. Ser. No. 2002/0031234 A1, U.S. Ser. No. 0054835 99A, WO 01/54451 A2 and WO 00/52959.

However, a complex structure with several microphones and a complex downstream circuit forming, for example, the difference of the microphone signals is required for this.

This use of several microphones, particularly also of additional electronic circuit elements, raises production costs.

Furthermore, it is difficult to accommodate a plurality of microphones including the downstream circuit elements in a miniaturized arrangement, such as for microphones in a mobile phone application or hearing aid application. Thus it is also difficult to produce microphones with directional characteristic fitting into an SMD housing.

Besides, using several microphones with downstream circuit elements results in an increased power consumption of the devices in which these components are used. This conflicts with the requirement of long operating times between two charging processes in portable devices, such as mobile phones.

In addition, final testing of this complex arrangement requires a considerable effort to ensure the correct cooperation of this number of components.

### SUMMARY OF THE INVENTION

It is an object of the present invention to provide a microphone and a method for producing a microphone having a directional characteristic and being easier to produce.

In accordance with a first aspect, the present invention provides a microphone having a substrate having an acoustically transparent substrate region; a lid having an acoustically transparent lid region; and a membrane which is held by a membrane carrier between the lid and the substrate; wherein the acoustically transparent substrate region or the acoustically transparent lid region has at least one impedance hole sized so that the acoustic impedance of the impedance hole is larger than the acoustic impedance of the acoustically transparent region of the respective other region of substrate region and lid region.

In accordance with a second aspect, the present invention provides a method for producing a microphone having the steps of providing a substrate having an acoustically transparent substrate region; providing a lid having an acoustically transparent lid region; attaching a membrane carrier to the substrate or the lid, which holds a membrane; and mounting the lid on the substrate so that the lid and the substrate are mechanically connected, wherein the acoustically transparent substrate region or the acoustically transparent lid region has at least one impedance hole sized so that an acoustic impedance of the impedance hole is larger than an acoustic impedance of the acoustically transparent region of the other region of substrate region and lid region.

The present invention is based on the finding that an impedance hole in the lid or the substrate which is sized so that it has a higher acoustic impedance than an acoustically transparent region of the microphone results in an increase in the directional sensitivity characteristic.

The present invention thus allows to produce a microphone with a directional sensitivity characteristic via a simple production method.

Another advantage of the invention is the possibility to machine the impedance hole increasing the automation degree of the production method.

The generation of a directional sensitivity characteristic by an impedance hole which is easy to produce also increases the cost efficiency of the production method.

As the impedance of the impedance hole depends on its geometric dimensions, there is an increased flexibility in the design of the directional sensitivity characteristic allowing the manufacturers to adapt a design concept to various usage requirements only by adapting the dimensions of an impedance hole.

This flexibility in the directional sensitivity characteristic may even be increased by an implementation of further impedance holes which are easy to produce and also influence the directional characteristic behavior. Therefore it is even conceivable to produce a basic variant with one impedance hole and to produce special modifications of the microphone by implementing another impedance hole or even several impedance holes, which favors the industrial mass production of these microphones.

Another advantage of the present invention is that the impedance hole to be produced may be introduced as late as in a late step of the production method. Thus it is possible to perform a prefabrication of microphones and then adapt the directional sensitivity characteristic of the microphones in a flexible and quick manner to the requirements of the market in a short and simple further production step.

What is also very advantageous is the fact that various directional sensitivity characteristics may be generated with a predetermined number of components. This facilitates stocking the required components.

Another advantage of the present invention is that the number of electric circuit elements in the microphones is limited according to the present invention. This results in a low power consumption which, in turn, increases the operating time between two charging processes of a battery of portable devices in which these microphones are used.

Furthermore, the sensitivity of the microphone with respect to electromagnetic interfering sources frequently existing in areas such as train stations or airports is reduced by the low number of electric components.

### BRIEF DESCRIPTION OF THE DRAWINGS

Preferred embodiments of the present invention will be discussed in more detail in the following with respect to the accompanying drawings, in which:

FIG. 1 is an embodiment of a microphone according to the present invention;

FIG. 1a is an embodiment of a microphone according to the present invention;

FIG. 1b is a schematic illustration of the microphone according to an embodiment of the present invention;

FIG. 1c is a schematic illustration of a further microphone according to an embodiment of the present invention;

FIG. 2a is an embodiment of a microphone according to the present invention;

FIG. 2b is a schematic illustration of the embodiment of the microphone of the present invention;

FIG. 3 shows the directional characteristic behavior for two embodiments of microphones according to the present invention;

FIG. 3a shows a polar diagram of a microphone according to an embodiment of the present invention having holes;

FIG. 3b shows a polar diagram of a microphone according to an embodiment of the present invention having holes;

FIG. 3c shows a simulated directional characteristic behavior for two embodiments of microphones according to the present invention;

FIG. 3d shows a measured directional characteristic behavior for two embodiments of microphones according to the present invention;

FIG. 4 is a microphone with directional characteristic according to a prior art embodiment; and

FIG. 5 is a microphone with directional characteristic according to a prior art embodiment comprising a cavity element.

### DESCRIPTION OF THE PREFERRED EMBODIMENTS

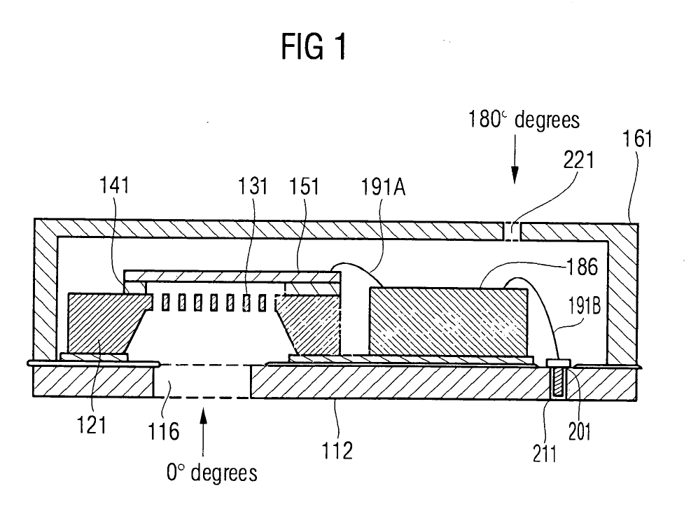

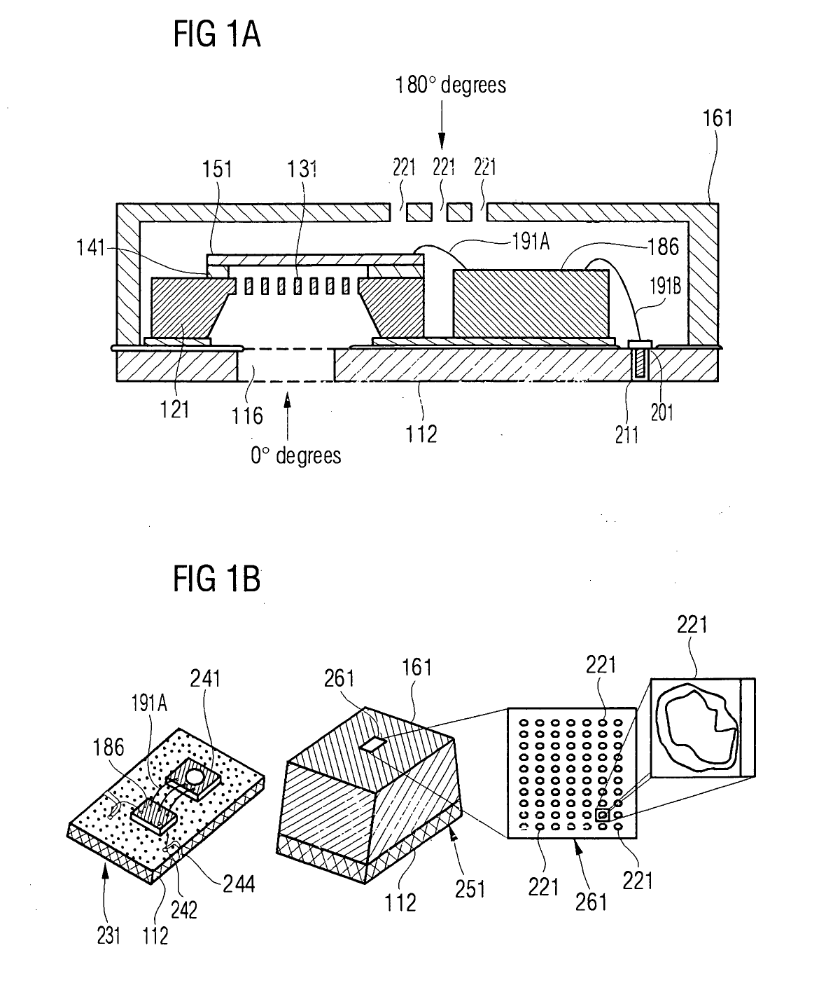

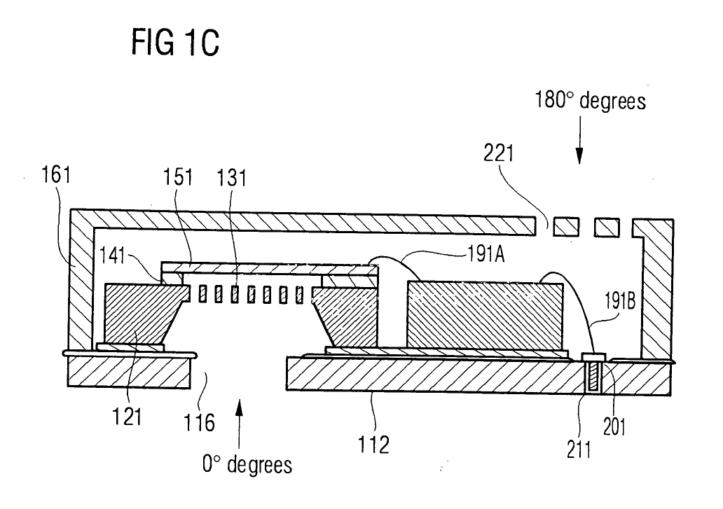

FIG. 1 shows an embodiment of a microphone of the present invention. It includes a substrate 112, a microphone sound hole 116, a membrane carrier 121, a counter structure 131, an intermediate layer 141, a membrane structure 151, a lid 161, a signal processing chip 186, bond wires 191a, 191b, a contacting 201, a contact hole 211 and an impedance hole 221. First, the electric operation of the microphone will be explained, before there will be an explanation of the generation of a directional characteristic.

The membrane structure 151 is located opposite to the sound hole 116. A pressure difference at the membrane structure 151 between the sound waves coming from below and the sound waves impinging on the membrane structure from above leads to a displacement of the same. This displacement changes the distance to the counter structure 131 which the sound waves pass without displacing it, whereby the capacity of the microphone capacitor formed of the membrane structure 151 and the counter structure 131 changes. The reason why the sound waves pass the counter structure 131 is an increased mechanical stiffness and the advantageous presence of perforations in the counter structure 131 which, during the production of the microphone chip, serve for allowing to etch the sacrificial layer away.

The intermediate layer 141 insulates the electrodes of the counter structure 131 and the membrane structure 151 from each other. The membrane carrier 121 holds the microphone capacitor arrangement over the sound hole 116.

Via the bond wire 191a, electric signals are passed from the microphone capacitor to the signal processing chip 186. The latter processes the signals from the microphone capacitor and passes them on to the contacting 201 via the bond wire 191b. Via a contact hole 211, this contacting 201 is connected to the exterior of the substrate 112. There may be further contacts there which are electrically connected to the contact hole 211, whereby the signals may be tapped off at these contacts and are passed on to a board below the entire arrangement. Thus the signals arriving at the contact hole 211 depend on the displacement of the membrane structure 151.

In the following, the directivity of the microphone will be discussed. The sound hole 116 is sized such that it does not represent any appreciable resistance for the sound propagation.

By the membrane carrier 121 and the membrane structure 151, a first space formed by the substrate 112, the membrane carrier 121 and the membrane structure 151 is acoustically separated from a second space formed by the lid region 161, the membrane carrier 121, the membrane structure 151 and the substrate region 112.

The impedance hole 221 comprises a smaller area than the sound hole 116. Therefore it represents an acoustic resistance, while the interior formed by the lid 161 and the substrate 112, the membrane carrier 121, the membrane structure 151 and the signal processing chip 186 forms the cavity which is comparable to an acoustic capacitance. The result is an acoustic RC element analogously to an electric circuit. This acoustic RC element generates an additional phase shift for the sound waves entering via the impedance hole 221 as compared to the sound waves entering at the microphone sound hole 116.

Therefore the sound waves arriving at the membrane structure 151 via the impedance hole 221 from a zero degrees direction, as illustrated in FIG. 1, experience two phase differences with respect to the sound waves arriving at the membrane structure 151 via the sound hole 116. A first phase difference is caused by the longer travel time to the impedance hole 221 than to the microphone sound hole 116, and a second phase shift results from the acoustic RC element formed of the impedance hole 221, here acting as acoustic resistance, and of the interior of the housing, here acting as acoustic capacitance. This phase shift is not so large for sound waves impinging on the microphone at an angle of 180°, that is from behind, because the path differences between the sound waves entering by the sound hole 116 and the impedance hole 221 are smaller than at an angle of 0°, which results in the directional characteristic of the microphone.

FIG. 1a shows a microphone according to a further embodiment of the present invention. In the following description of the preferred embodiments, elements that are equal or act equally are provided with the same reference numerals.

Unlike the first embodiment of the invention in FIG. 1, the microphone now comprises several impedance holes 221. The result is again an acoustic RC element now formed of the impedance holes 221 having a high acoustic resistance and the interior of the housing. The interior of the housing again functions as acoustic capacitance. The acoustic resistance of the impedance holes 221 is formed by the flow resistance of the impedance holes 221 which are preferably implemented with small geometric dimensions as compared to the sound hole 116.

A produced illustration of the embodiment of the invention discussed in FIG. 1a is explained by FIG. 1b. From left to right, it shows a substrate illustration 231, an overall illustration 251, an impedance hole region 261 and the impedance hole 221 in schematic illustration.

The substrate illustration 231 shows an embodiment of the substrate 112, the signal processing chip 186, the bond wires 191a, a microphone chip 241, a contact 242 and a contacting 244. The signal processing chip 186 and the microphone chip 241 are mounted on substrate 112.

The overall illustration 251 consists of the substrate 112 and the lid 161. The lid 161 is mounted on the substrate 112 so that it is mechanically connected to the same. In addition, the lid 161 includes the impedance hole region 261. This impedance hole region 261 comprises a field of the impedance holes 221.

The impedance hole region 261 is schematically illustrated in the third arrangement counted from the left.

Far right, there is a schematic illustration of the impedance hole 221.

The directional characteristic of the microphone may be influenced by the number of impedance holes 221, their sizes, their depths and the arrangement of the impedance holes 221 in the field 261.

FIG. 1c shows another embodiment of the present invention, wherein now an arrangement position of the impedance holes 221 is changed. The holes 221 are no longer arranged near a center of the microphone, but on the right edge. A change in the directional characteristic of the microphone resulting therefrom is explained hereinafter in a few figures.

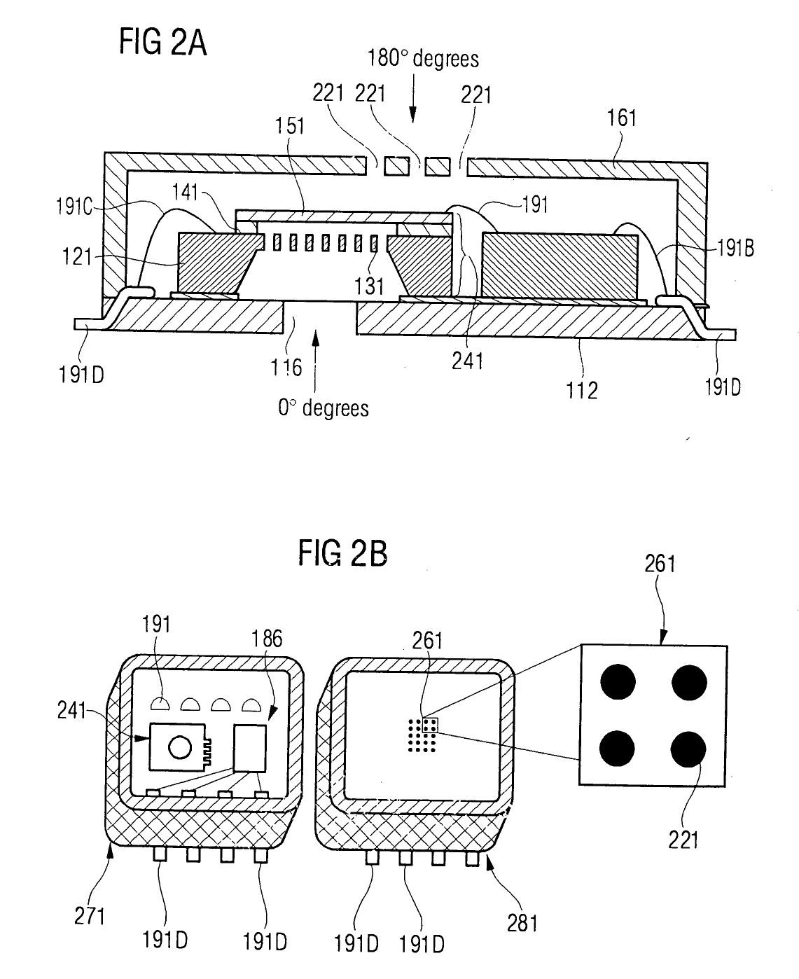

FIG. 2a shows another embodiment of a microphone of the present invention. The directivity of the microphone again results from the impedance holes 221 representing an acoustic impedance, and the interior of the microphone forming a cavity and thus an acoustic capacitance. The electric connection to a board is established via the contactings 191d. The substrate 112 may be advantageously implemented as a premold substructure, while the lid 161 is, for example, implemented as a metal lid.

FIG. 2b shows a schematic illustration of the embodiment according to the present invention explained in FIG. 2a. From left to right, there can be seen a premold substructure 271, a housing embodiment 281 and the impedance hole region 261.

The premold substructure 271 contains the microphone chip 241 and the signal processing chip 186 and is provided with contacts 191d leading to the outside. By means of those, the premold substructure is connected in a mechanical and electrically conductive way to a board not shown here.

The housing embodiment 281 also comprises the contacts 191d to the board and, in addition, includes the impedance hole region 261.

The impedance hole region 261 is shown projected out in the arrangement on the right. Again the impedance holes 221 are apparent. The task of the impedance holes 221 and the impedance hole region 261 is to form an acoustic resistance forming an acoustic RC element with the interior of the premold housing 281.

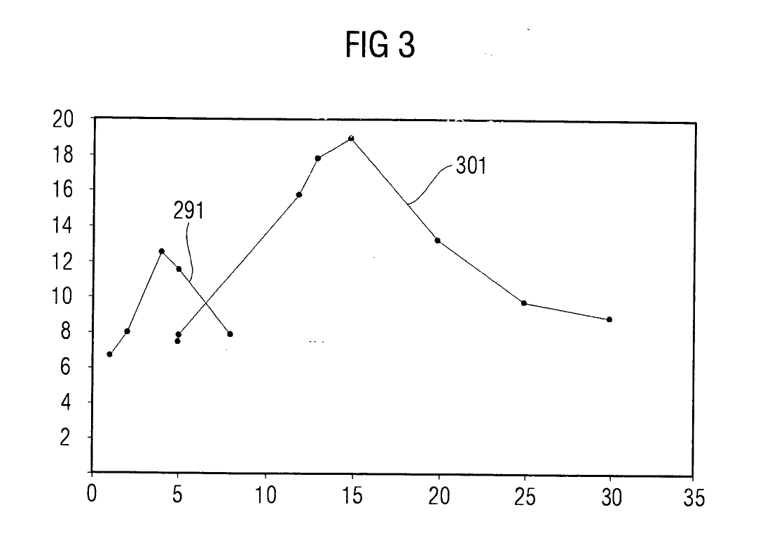

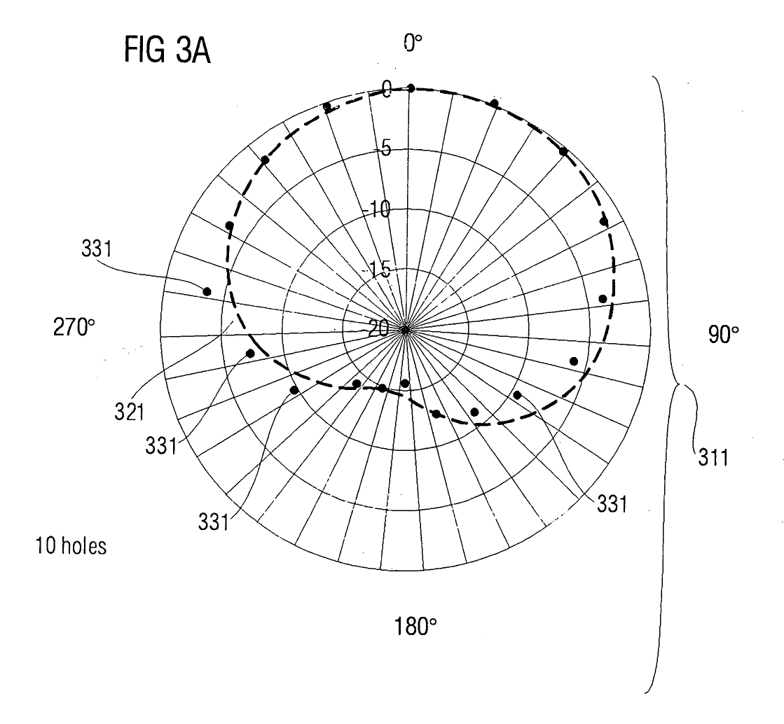

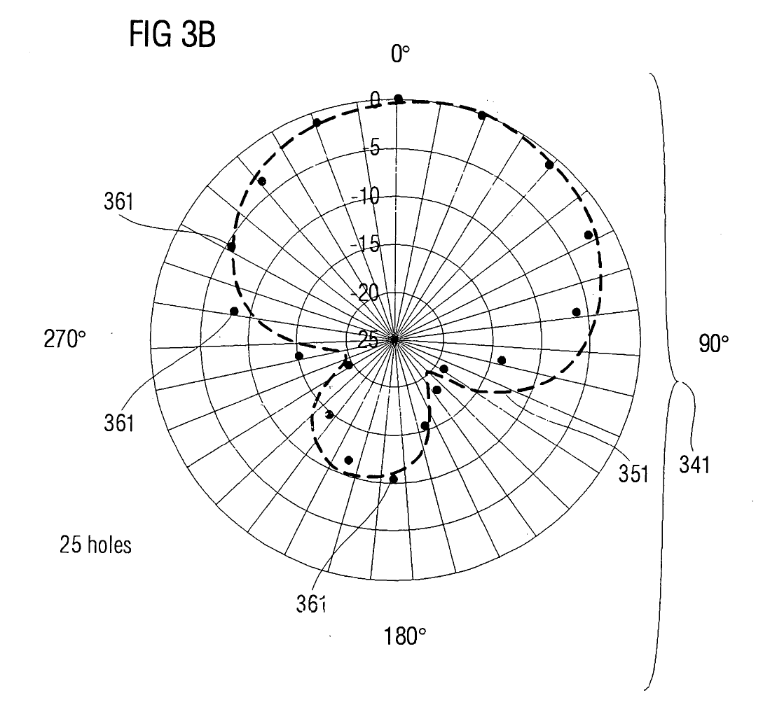

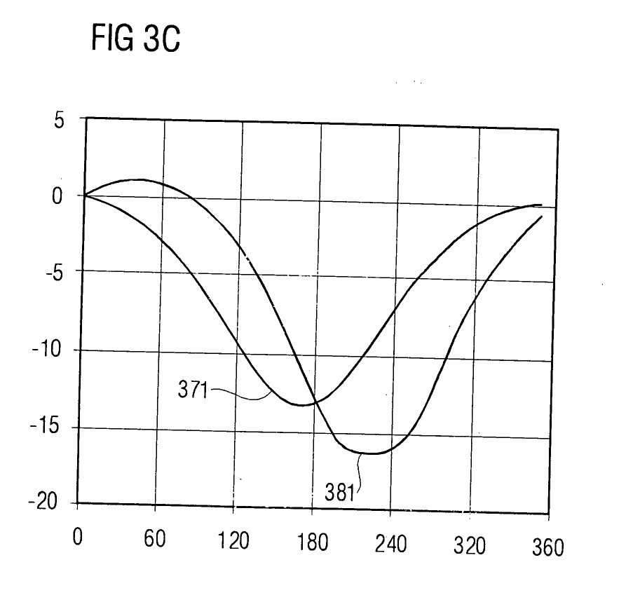

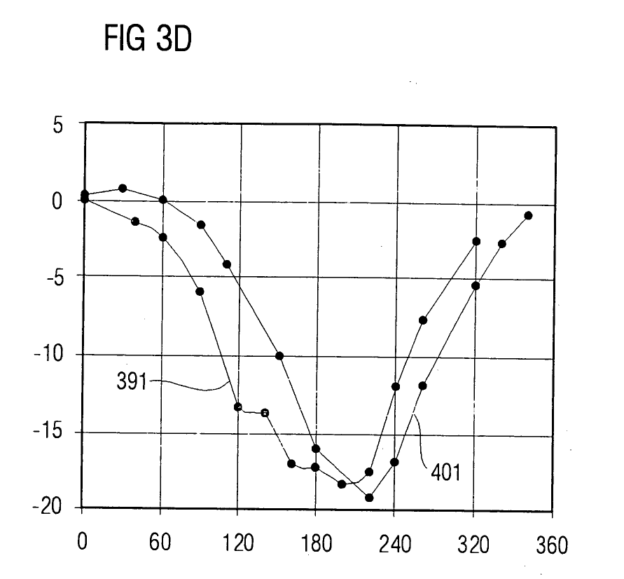

FIG. 3 shows the curve of the directional characteristic as a function of a number of impedance holes 221 in microphones designed according to embodiments of the present invention. The number of holes 221 in the impedance hole region 261 is plotted on the x-axis, while the directional characteristic for a sound wave of a frequency of 1 kHz and a difference in the angle of incidence of 180° is plotted on the y-axis. The representation of the directional characteristic on the y-axis is in dB values corresponding to a logarithmic representation of sound pressure intensities.

The graph 291 shows the curve of the directional characteristic as a function of the number of impedance holes 221, when the diameter of the circular impedance holes 221 is 160 μm and the thickness of the lid is 100 μm. The graph 301, however, shows the curve of the directional characteristic as a function of the number of impedance holes 221 in the microphone whose impedance hole diameter is 100 μm and whose lid thickness is 50 μm. Thus, the areas of the impedance holes are considerably smaller than the area of the sound hole 116.

It can be seen that, in the case of a small impedance hole diameter and a low lid thickness, the directional characteristic, particularly its maximum value, is stronger than in the case of a larger impedance hole diameter and a higher lid thickness. It also is to be noted that the lid thickness corresponds to the depth of the impedance holes 221.

Another effect shown in FIG. 3 is that, in the case of the impedance holes 221 of small area and little depth, the maximum only appears with a larger number of holes 221 than in the case of the microphone with the impedance holes 221 of larger diameter and higher lid thickness. At the same time, this illustration confirms that the directional characteristic of a microphone depends on the depth of the impedance holes 221, the area of the impedance holes 221 and the number of impedance holes 221. By means of these three parameters, microphones adapted with respect to their directional characteristic behavior are easy to produce.

A further parameter to adapt the directional sensitivity characteristic of the microphones illustrated in FIG. 3 is an attenuation element, which may be implemented, for example, as cloth or felt and is applied to one of the impedance holes 221.

FIG. 3a shows a polar diagram 311 illustrating an attenuation behavior of the microphone having 10 holes. A graph 321 illustrates simulation results, while the dots 331 illustrate the measured results for this number of holes.

FIG. 3b shows a polar diagram 341 illustrating an attenuation behavior of the microphone having 25 holes. A graph 351 again illustrates simulation results, as in FIG. 3a, but for a larger number of impedance holes 221, while the dots 351 illustrate the measured results for this changed number of holes 221.

A comparison of the two polar diagrams 311 and 341 illustrates that the attenuation maximum is higher for the larger number of holes 221, and that a shape of the graphs 321, 351 changes. For example, the graph 321 with 10 holes has the curve of a kidney, while the shape of the graph 351 corresponds to a hyper kidney.

FIG. 3c illustrates a course of the curves of the directionalities illustrated in FIG. 1a and FIG. 1c which are determined in simulations. The attenuation is plotted in dB on the y-axis, which corresponds to a representation in logarithmic scale, while the angle of incidence is plotted linearly on the x-axis. A graph 371 illustrates the curve of the attenuation of the microphone shown in FIG. 1a, while a graph 381 shows the curve of the attenuation of the microphone illustrated in FIG. 1c.

It is apparent that the microphone of FIG. 1c in which the impedance holes 221 are arranged near the edge has a higher attenuation maximum than the microphone of FIG. 1a. In addition, the location of the attenuation maximum is also shifted. The attenuation maximum for the microphone of FIG. 1a occurs at an angle of incidence of about 160° and, for the microphone of FIG. 1c, it occurs at an angle of incidence of about 220°. Changing the position of the impedance holes 221 thus also allows to vary the location of the attenuation maximum of the microphone with respect to various angles of incidence.

FIG. 3d illustrates a measured curve of the attenuation of the microphones of FIG. 1a and FIG. 1c. Again, the attenuation is plotted in dB on the y-axis, which corresponds to a representation in logarithmic scale, while the angle of incidence is linearly plotted on the x-axis. A graph 391 reflects the measured curve of the attenuation at the microphone of FIG. 1a, and the graph 401 illustrates the measured curve of the attenuation at the microphone of FIG. 1c. Similar to the illustration in FIG. 3c, where the curves are simulated, it can be seen that the attenuation maximums of the two microphones have different heights and occur at different angles of incidence.

In their schematic illustrations, the above embodiments show microphones whose geometric dimensions are in the order of millimeters and which are, in part, implemented as SMD devices. Alternatives are structures which are not in the order of millimeters and are not implemented as SMD devices.

In addition, the number of impedance holes 221, their dimensions, and their spacing from each other may vary.

Also, semiconductor capacitor microphones 241 are shown in the embodiments, but other microphone types, such as electret microphones, may also be used instead of the capacitor microphones.

Furthermore, a mounting of the membrane carrier 121 and/or further chips in the microphone housing between lid 161 and substrate 112 may be implemented as desired, the mounting may, for example, be alternatively achieved by flip chip mounting or by gluing the membrane carrier 121 to the substrate 112.

There are also various possibilities to acoustically separate the space formed by the membrane carrier 121, the membrane 151 and the sound hole 116 from the remaining interior of the housing formed of substrate 112 and lid 161. For example, a glue, such as an underfiller, may be used for acoustic separation between substrate 112 and microphone chip 241, if the microphone chip 241 is applied to the substrate 112 by means of flip chip mounting.

The way in which the microphone is mechanically and electrically connected to a board or another carrier may also be varied as desired. In the above embodiments, the contact holes 211 serve for connecting the contactings 201 on the inside of the housing to the contactings on the outside, or bond wires 191d are used to connect the contactings on the inside to the contactings on the board electrically and mechanically.

In addition, it is possible to vary the geometrical shape of substrate 112 and lid 161 of the microphone as desired, which facilitates the usage of these microphones in mobile phones.

Furthermore, the acoustic resistance of the impedance holes 221 may certainly be combined with the acoustic resistance of an attenuation element, at least for part of the impedance holes 221, which allows an additional degree of flexibility in the design of the directional sensitivity characteristic.

The above embodiments have shown that, in sensor technology, the lowest signal to be detected and/or the signal quality corresponding to a signal-noise-ratio is limited by external interfering sources and the noise of the sensor. The above embodiments have shown a solution for reducing external interfering signals in acoustic sensors, such as a microphone, by a direction-dependent sensor characteristic.

For regulating environment noise and the deliberate orientation to a sound source, so-called directional microphones are used having a sensitivity depending on the angle of incidence of the sound waves. For realizing a directivity in microphones, different concepts may be pursued, some of which are illustrated in the above embodiments. What is not shown in the above embodiments are so-called microphone arrays in which the direction-dependent travel time differences between several unidirectional microphones connected together and locally separated are evaluated with the aid of an intelligent signal processing. This design, however, has the disadvantage that such a directional microphone system puts high requirements to the sensitivity adaptation between the microphones in the array and requires the cost and space intensive usage of two or more microphones.

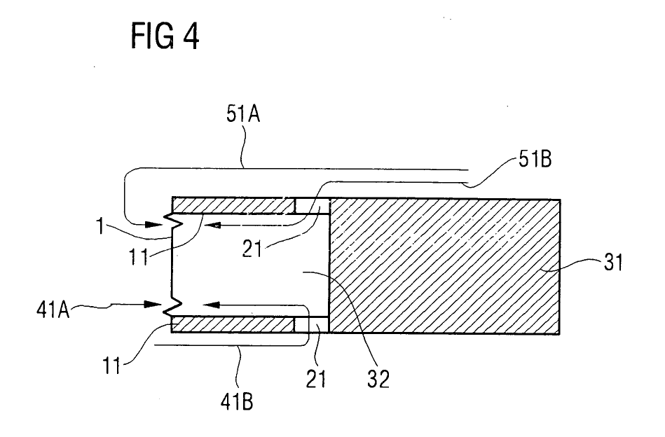

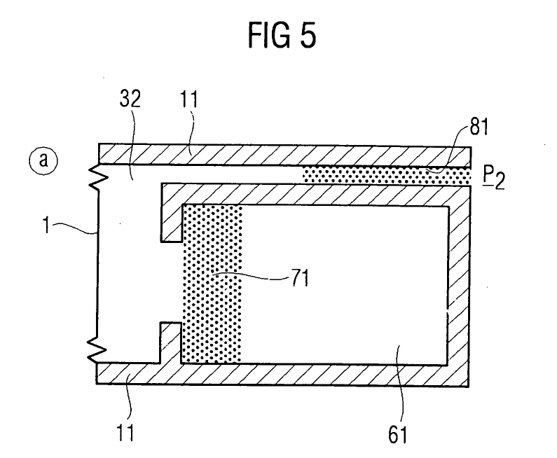

Alternatively, the above embodiments show that a single microphone may be used which comprises two locally separated sound inlets. A simple design is a so-called pressure difference receiver, also referred to as pressure gradient receiver and comprising a non-attenuated sound inlet on both sides. This principle is explained in FIG. 4. With an angle of incidence of 0° related to the surface perpendicular of the membrane 1, there is a path and/or phase difference and thus a pressure difference unequal 0 at the membrane 1, which may be detected via the displacement of the membrane 1. The sound paths for an angle of incidence of 180°, however, are identical and the difference of the pressure amplitudes on the two sides of the membrane disappears. This means that sound waves with an angle of incidence of 180° do not cause displacement of the membrane 1. In the polar diagram in which the directional characteristic is illustrated the result is a characteristic kidney shape with a maximum sensor sensitivity at a direction of incidence of 0°. As, due to the path difference, the phase difference depends on the frequency, the sensitivity also depends on the frequency and thus decreases towards lower frequencies.

An improvement of the frequency response is achieved in the above embodiments, when an acoustic filter element is used for phase shifting in addition to the path difference. This additional phase shift may be used for compensating a possible path difference at an angle of incidence of 180° which, for example, applies for the case that the membrane 1 is not directly at a sound inlet 21. The acoustic filter element for phase shifting is formed by a cavity 61 and an attenuation element 81. Here the cavity 61 functions as potential energy storage, which is comparable to an electric capacitance, and the attenuation element 81 functions as acoustic resistance, which is comparable to an electric resistance R. This arrangement with a cavity 61 and an acoustic resistance 81 causes a phase rotation analogously to an electric RC filter.

The above embodiments also show that a microphone which is produced micromechanically with the methods of semiconductor technology as silicon microphone may be implemented as SMD, i.e. surface mount device. A capacitive silicon microphone may be implemented in an SMD with two sound inlets. Here, an attenuation element applied to a sound inlet hole, together with the housing volume, may form the phase shifting filter for improving the frequency response and the directivity.

Furthermore, there are also microphones in the housing technology for silicon microphones which use two sound inlets, which, however, are not suitable for generating a directivity.

What is advantageous in the above embodiments is that an acoustic filter element for achieving and improving directivity is not realized by an additional cavity and/or an additional attenuation element, but that the invention uses the existing microphone housing volume and specially adapted apertures 221 in the housing. The apertures 221, such as impedance holes 221, can be implemented such that the flow resistance due to the viscous air friction in the apertures 221 provides the required acoustic resistance. What is advantageous in this kind of design of a directional sensor is that a particularly flexible adaptation to various housings and thus an improvement of the directivity can be achieved, because, in contrast to an attenuation element, the flow resistance of the apertures 221 is variable in a broad value range by their geometry and number.

The embodiments of microphones of the present invention are designs and housings realizing directivity in acoustic sensors, such as in a micromechanically produced silicon microphone, such as an SMD, in an especially simple and flexible way. The above embodiments according to the present invention show a micromechanical silicon microphone attached to a perforated base, such as a printed circuit board, and in which the housing volume may be realized by a cap 161, such as a metal cap or a premold cap. The cap 161 has one or more apertures 221 in the cap top. The lower sound inlet is advantageously realized by a relatively large aperture 116, such as apertures 116, whose lateral dimensions are larger than 0.3 mm, so that the sound may enter non-attenuated and without phase shift. However, the second sound inlet in this embodiment may be realized by an aperture 221 or several apertures 221 with relatively small cross-section, for example typically with lateral dimensions less than 0.3 mm, so that the aperture 221 and/or apertures 221 have a non-negligible acoustic resistance. This acoustic resistance together with the housing volume then forms the acoustic filter. The apertures 221 may, for example, be drilled, etched or produced by laser. Advantageously, the apertures 221 have a minimal cross-section in large number with little depth. The produced demonstrator of a capacitive silicon microphone may, for example, be implemented as SMD on an FR4 substrate with molded cap 161 into which small holes 221, for example having a diameter of about 100 μm, are made by laser. The microphone in the above embodiments may also be inserted in a premold housing and closed with a lid 161. The lid 161 may then be a metal or plastic cap.

The demonstrator of a capacitive silicon microphone thus produced may be implemented as SMD in a premold housing with a metal lid 161 into which small holes 221 having a diameter of about 100 to 200 μm have been etched. The relatively large apertures corresponding to the sound hole 116 may also be in the cap 161 and/or the lid 161, and the narrow apertures 221 may be in the base and/or the housing floor. In such embodiments, the acoustic filter is comprised of the flow resistance of the narrow apertures 221 and the cavity of the microphone chip.

If both sound inlets are realized by sound apertures, two acoustic filters are provided for the acoustic optimization of frequency response and directivity.

In the above embodiments, the acoustic resistance of the phase rotating RC filter was defined by the flow resistance of the narrow apertures 221, whereby the directivity may be directly improved. Three design parameters are available for this: The flow cross-section of an aperture 221, the number of apertures 221 and the lid thickness. The directivity thus measured corresponding to a sound level difference at a sound entry angle of 0° and/or 180° related to a frequency of 1 kHz may be represented for a produced silicon microphone accommodated in a premold housing with a metal plate as lid 161 into which circular apertures are etched as impedance holes 221. The hole diameter, the number of holes and the lid thickness may be varied. With this arrangement, a phase shift and/or an acoustic resistance necessary for good directivity may be achieved by the flow resistance of narrow apertures 221 with which a directivity of up to 19 dB may be demonstrated.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-18. (canceled)

19: A method for producing a microphone comprising the steps of:
providing a substrate comprising an acoustically transparent substrate region;
providing a lid comprising an acoustically transparent lid region;
attaching a membrane carrier to the substrate or the lid, which holds a membrane; and
mounting the lid on the substrate so that the lid and the substrate are mechanically connected,
wherein the acoustically transparent substrate region or the acoustically transparent lid region comprises at least one impedance hole sized so that an acoustic impedance of the impedance hole is larger than an acoustic impedance of the acoustically transparent region of the other region of substrate region and lid region.

20: A microphone comprising:
a substrate comprising an acoustically transparent substrate region;
a lid having an acoustically transparent lid region;
a membrane which is held by a membrane carrier between the lid and the substrate; and
at least one impedance hole formed in either the acoustically transparent substrate region or the acoustically transparent lid region, the at least one impedance hole sized so that the acoustic impedance of the impedance hole is larger than the acoustic impedance of the one of the acoustically transparent substrate region or the acoustically transparent lid region in which the impedance hole is not formed.

21: The microphone of claim 20, wherein the acoustically transparent substrate region includes a hole and the acoustically transparent lid region includes a hole, wherein one hole is the impedance hole and the other hole is a sound hole, and the sound hole has an area such that the impedance of the sound hole is less than the impedance of the impedance hole.

22: The microphone of claim 20, wherein an area of the one of the acoustically transparent substrate region or the acoustically transparent lid region in which the impedance hole is not formed and an area of the membrane at least partially overlap.

23: The microphone of claim 20, wherein the one of the acoustically transparent substrate region or the acoustically transparent lid region in which the impedance hole is not formed, the membrane carrier and the membrane form a first space acoustically separated from a second space formed of the lid region, the substrate region, the membrane carrier and the membrane.

24: The microphone of claim 20, further comprising a further impedance hole formed in the same acoustically transparent region of the lid or the substrate region within which the first impedance hole is formed, the further impedance hole being spaced apart from the first impedance hole and wherein the acoustic impedance of the further impedance hole is larger than the acoustic impedance of the one of the acoustically transparent substrate region or the acoustically transparent lid region in which the impedance hole is not formed.

25: The microphone of claim 21, further comprising between 5 and 60 impedance holes.

26: The microphone of claim 21, further comprising a sound attenuating element applied to the impedance hole.

27: The microphone of claim 20, wherein the impedance hole comprises an area which is less than 0.1 mm².

28: The microphone of claim 20, wherein the depth of the impedance hole is less than 1 mm.

29: The microphone of claim 20, wherein the area of the impedance hole is less than 50% of the area of the one of the acoustically transparent substrate region or the acoustically transparent lid region in which the impedance hole is not formed.

30: The microphone of claim 20, wherein the membrane carrier and the membrane are implemented in a semiconductor microphone structure comprising a membrane structure and a counter structure.

31: The microphone of claim 30, wherein the counter structure is opposite to the sound hole and the counter structure comprises perforations to facilitate the passage thereby of sound waves.

32: The microphone of claim 30, wherein the semiconductor microphone structure is applied to the substrate with an output area.

33: The microphone of claim 32, further comprising an underfiller applied to the substrate between the semiconductor microphone structure and the substrate or around the semiconductor microphone structure accoustically separating a first space from a second space.

34: The microphone of claim 32, wherein the substrate comprises a sound hole, and the lid comprises an impedance hole.

35: The microphone of claim 30, wherein the membrane structure is opposite to the semiconductor microphone structure of a surface including an impedance hole.

36: The microphone of claim 34, further comprising a signal processing chip accommodated in a housing formed of the substrate and the lid.

37: The microphone of claim 20, wherein the substrate region has a substrate thickness and the lid region has a lid thickness and wherein the depth of the impedance hole is equal to the substrate thickness or the lid thickness.
